(19) United States
(12) Patent Application Publication
(10) Pub. No.: US 2022/0322895 A1
(43) Pub. Date: Oct. 13, 2022

(54) GRAB RAIL

(71) Applicant: EVEKARE PTY LTD, Sydney (AU)

(72) Inventor: Glenn HOLLAND, Vaucluse (AU)

(73) Assignee: EVEKARE PTY LTD, Sydney (AU)

(21) Appl. No.: 17/634,864

(22) PCT Filed: Aug. 7, 2020
(86) PCT No.: PCT/AU2020/050816

§ 371 Date: Feb. 11, 2022

(30) Foreign Application Priority Data
Aug. 13, 2019 (AU) 2019902921

(51) Int. Cl. A47K 17/02; E04F 11/18; F21V 9/32

(52) U.S. Cl. CPC A47K 17/022; E04F 11/1808; F21V 9/32; E04F 2011/1872

(57) ABSTRACT

A grab rail (10) includes an elongate central grip region (12) extending in a linear direction and two end portions (14). Each end portion (14) includes an elbow formation (18) extending from and contiguous with the grip region through to a direction generally transverse to the grip region and terminating in a surface engaging formation (20). The central grip region (12) includes a photo luminescent material that accumulates energy under normal or day light conditions and automatically emits light under low light conditions to glow in the dark. The grab rail does not require a power source and provides enhanced visibility in low or dark lighting conditions, and is particularly useful in care facilities and where people suffer from mobility issues.

### FIELD OF THE INVENTION

The present invention relates to hand rails used for physical support that are typically referred to as “grab rails” or “grab bars”.

The invention has been developed primarily for retrofitting applications in bathrooms and other rooms in domestic residences and hotel and institutional accommodation facilities. However, it will be appreciated that the invention need not be limited to such applications.

### BACKGROUND OF THE INVENTION

The following discussion of the prior art is intended to place the invention in an appropriate technical context and enable the associated advantages to be fully understood. However, any discussion of the prior art throughout the specification should not be considered as an admission that such art is widely known or forms part of the common general knowledge in the field.

Grab rails in the form of simple wall mounted rails have been used extensively in homes, care facilities, hotels and hospitals and the like, to provide a means of support for those that may be unsteady or infirm, especially in bathroom areas. These simple rails work well during daylight or in brightly illuminated areas, as a user will have consciously or subconsciously observed the rail, and if needed suddenly, instinctive reactions and good lighting will assist them in finding the rail to get support.

However, when using facilities such as bathrooms during periods of low light such as at night, when the main lighting is usually switched off, there is not the same degree of observation. For example, if the illumination is a simple permanent low wattage night light, all features within the room will have less prominence than during the day. Similarly, if the user must locate a light switch and turn it on when tired and sleepy, the effect is often quite blinding, and again the rail or rails lose prominence in comparison to the rest of the surroundings.

To try and address this problem, several solutions have been proposed that aim to illuminate the rail to make it prominent within a room and easy to locate when needed.

A first type of a grab rail is configured to include lighting elements along the length of the rail that are mains powered that need to be connected to a power source and a switching mechanism. Clearly the need for mains power makes these comparatively difficult to retrofit into an existing building. There are alternative designs that are battery operated. However, some of these options still require the user to consciously first find the switch in the dark to illuminate the rail and even where this isn't required there is still the expense of providing a light and switching mechanism and the need to maintain these mechanisms and replace lights and batteries when required.

Another solution is offered by the Great Grabz Unique touch grab rail, which is a smooth finish arcuate end fixed rail of a glow in the dark material. This grab rail is aesthetically attractive, but has limited use in a practical application, particularly in care facilities where many users have arthritis or other mobility issues. This is primarily due to the optimal grab region of the rail being limited in length because the rail curves from the centre towards the substrate surface or wall to which it is to be attached limiting rear clearance behind the rail towards each end.

It is an object of the present invention to overcome or ameliorate at least one of the disadvantages of the prior art, or to provide a useful alternative.

It is an object of the invention in at least one preferred form to provide a grab rail that has enhanced visual distinctiveness without requiring a power source.

It is an object of the invention in at least one preferred form to provide a grab rail that has enhanced visual distinctiveness and is easily useable particularly for those in care facilities and those with mobility issues.

### SUMMARY OF THE INVENTION

According to the invention there is provided a grab rail including:
an elongate central grip region extending in a linear direction; and
two end portions each including an elbow formation extending from and contiguous with the grip region through to a direction generally transverse to the grip region and terminating in a surface engaging formation,
wherein at least the central grip region includes a photo luminescent material that accumulates energy under normal or day light conditions and automatically emits light under low light conditions to glow in the dark.

Preferably, the grab rail includes at least two photo luminescent materials that each generate a different colour light. More preferably, one of the photo luminescent materials is for the grip region and the other of the photo luminescent materials is for the end portions.

Preferably, the central grip region and the end portions are moulded from a polymeric material. More preferably, the photo luminescent material is incorporated into the polymeric material.

Preferably, the grab rail is reinforced with a metal material for high load applications. More preferably, the grab rail is formed from a metal material for high load applications.

Preferably, the photo luminescent material is provided as a coating.

Preferably, the central grip region includes a plurality of longitudinally disposed and outwardly extending grip formations. More preferably, the outwardly extending grip formations are sized to enhance identification of the grip region both in normal light conditions and low light conditions.

Preferably, each surface engaging formation includes a mounting flange.

Preferably, each end portion includes an elbow formation. More preferably, each elbow formation includes a conforming area of reduced diameter, the conforming area being adapted to co-axially and slidably engage with corresponding apertures at each end of the central grip region during assembly of the of the grab rail.

Preferably, each end portion includes a cover.

Preferably, identification of the grip region is enhanced by using a brighter photo luminescent material or density of photo luminescent material, and/or by means of creating a greater surface area that results in increased light emission from that area.

### BRIEF DESCRIPTION OF THE DRAWINGS

A preferred embodiment of the invention will now be described, by way of example only, with reference to the accompanying drawings in which:

FIG. 1 is a left side perspective view of a grab rail according to one embodiment of the present invention, shown in normal light conditions;

FIG. 2 is right side perspective of a grab rail according to FIG. 1;

FIG. 3 is top view of a grab rail according to FIG. 1;

FIG. 4 is bottom view of a grab rail according to FIG. 1;

FIG. 5 is front view of a grab rail according to FIG. 1;

FIG. 6 is an exploded front view of a grab rail according to FIG. 1, showing the modular design of invention when separated into its component pieces and fasteners;

FIG. 7 is a left side perspective view of a grab rail according to FIG. 1; shown glowing in low light conditions; and

FIG. 8 is a right side perspective view of a grab rail according to FIG. 1; shown glowing in low light conditions.

### DESCRIPTION OF PREFERRED EMBODIMENTS OF THE INVENTION

Exemplary embodiments of the present invention will now be described in detail with reference to the accompanying drawings. In the drawings, the same elements are denoted by the same reference numerals throughout. In the following description, detailed descriptions of known functions and configurations incorporated herein have been omitted for conciseness and clarity.

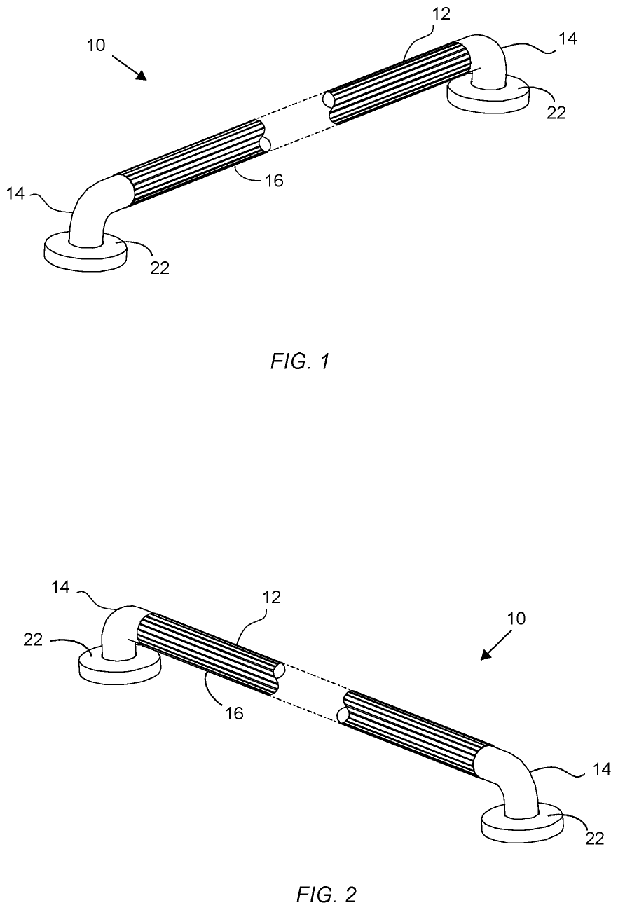

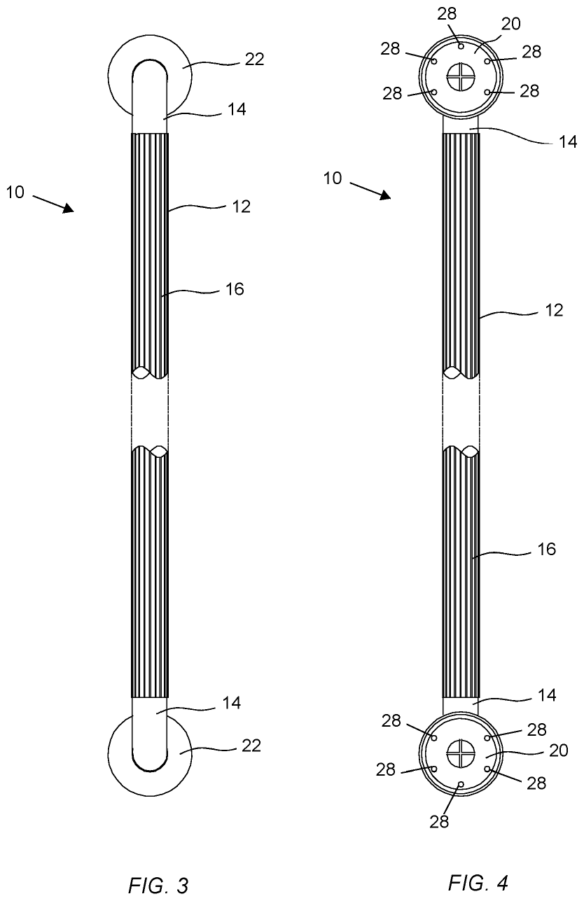

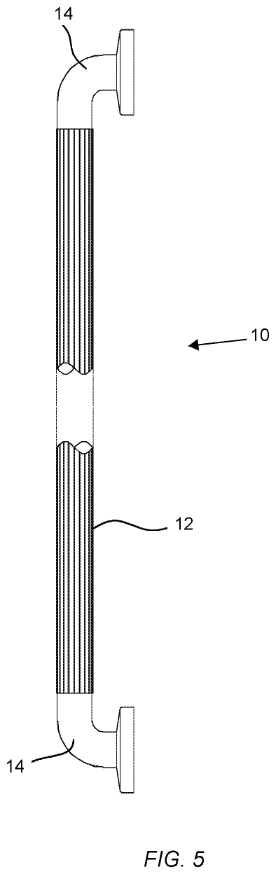

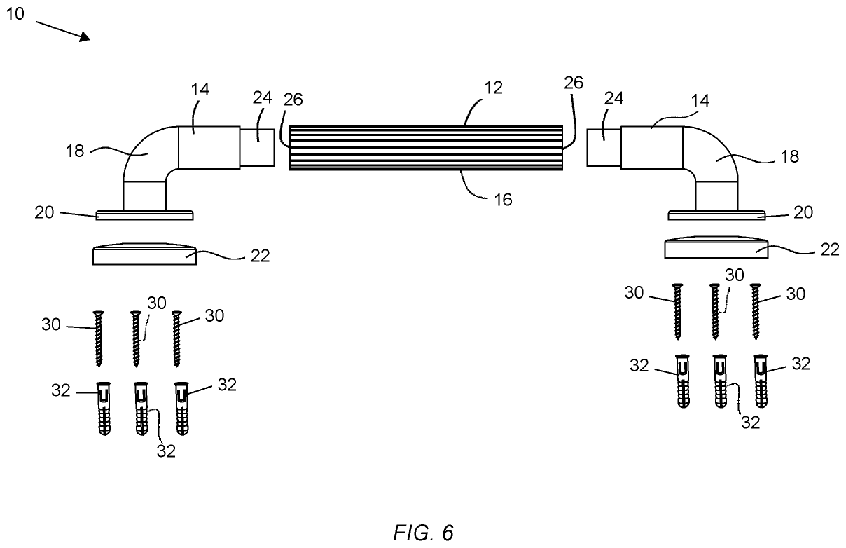

Referring initially to FIGS. 1 to 5, there is provided a grab rail 10 according to the present invention. The grab rail 10 includes a central grip region 12, and two end portions 14 extending from each end of the central grip region.

The central grip region 12 is elongate, circular and tubular and extends in a straight linear direction. The central grip region 12 includes a plurality of longitudinally disposed grip formations 16 outwardly extending from its surface. These grip formations 16 improve the frictional gripping engagement between a user's hand and the grab rail. The grip formations 16 are also sized to be visually distinctive and easily recognisable to enhance identification of the grip region both in normal and low light conditions.

The end portions 14 each include elbow formations 18 having a complimentary circular profile to the central grip region 12. The end portions are used for transversely spacing the grip region 12 away from a mounting surface. While the central grip region 12 is primarily intended to be the gripping contact surface for a user's hands, at least a portion of each end portion 14 may also be used for gripping.

In order to secure the grab rail 10 to a mounting surface, the elbow formations 18 terminate at surface engaging formations in the form of cylindrical flanges 20. The end portions 14 further include covers 22, for covering the cylindrical flanges 20 once engaged with a mounting surface.

According to the invention, at least the grip region 12 of grab rail 10 includes a photo luminescent material that accumulates energy under normal light conditions and emits light under low light conditions to glow in the dark. In this way, the grab rail 10 can be seen in low light conditions.

According to the illustrated embodiment, the central grip region 12 and the end portions 14 are formed from a polymeric material including the photo luminescent material so that the complete grab 10 may glow in the dark. In one embodiment, the polymeric material is acrylonitrile butadiene styrene (ABS), and the photo luminescent material is in the form of pigments of strontium aluminate. However, other polymeric and photo luminescent materials may be used without departing from the scope of the invention.

Alternatively, the central grip region 12 and the end portions 14 are coated with the photo luminescent material. Further, according to the illustrated embodiment, the end portions 14 and central grip region 12 each respectively include a luminescent material which emits a differently coloured light to define a dual colour pattern. In the illustrated embodiment, this dual colour pattern is defined by a yellow green colour for the central grip region 12, and a sky-blue colour for the end portions 14, however, other colours may be used without departing from the scope of the invention. In this way, the user can easily identify the central grip region 12 by increasing its visual distinctiveness. Further, the dual colour pattern emphasises the clearance from a mounting surface provided by the end portions 14, allowing for easier practical use.

According to the illustrated embodiment, it is proposed that once fully charged, the glow time for the central region 12 is maintained for approximately twelve hours. The proposed luminescence for the central region 12 during this period is estimated as per the following table:

| | Luminescence in mcd/m² |
|---|---|
| Time | (Milli Candela per Square Meter) |
| After 1 minute | 3600 |
| After 10 minutes | 620 |
| After 60 minutes | 101 |

Similarly, according to the illustrated embodiment, it is proposed that once fully charged, the glow time for the end portions 14 is maintained for approximately eight hours. The proposed luminescence for the end portions 12 during this period is estimated as per the following table:

| | Luminescence in mcd/m² |
|---|---|
| Time | (Milli Candela per Square Meter) |
| After 1 minute | 450 |
| After 10 minutes | 75 |
| After 60 minutes | 20 |

In a further embodiment, the luminescence of the grip region 12 is enhanced by using a brighter photo luminescent material or density of photo luminescent material, and/or by means of creating a greater surface area that results in increased light emission from that area. The central grip region 12 and the end portions 14 may also be reinforced by a metal material and, in some high load applications, may be completely formed of a metallic material that is coated with a photo luminescent material. This coating normally occurs by way of powder coating, or by painting.

As best seen in FIG. 6, it can be seen how the central grip region 14, and two end portions 14 combine to form the grab rail 10 shown in FIG. 1 according to the illustrated embodiment. In this regard, each elbow formation 18 includes a conforming area 24 of reduced diameter. These conforming areas 24 each co-axially and slidably engage with corresponding apertures 26 at each end of the central grip region 12 to define a complimentary fit. When the grab rail 10 formed from a polymeric material, an adhesive is used to retain each elbow with respect to each end of the central grip region 12. In some circumstances, where the grab rail 10 is formed from a metallic material, grub screws (not shown) are used to retain each elbow with respect to each end of the central grip region 12.

With additional reference to FIG. 4, each cylindrical flange 20 includes a plurality of countersunk mounting holes 28 for receiving a plurality of corresponding mounting screws 30. The mounting screws 30 pass through each mounting hole 28 and screwingly engage with the wall surface to secure the grab rail 10 upon installation. In the illustrated embodiment, the mounting screws 30 are adapted to screwingly engage with wall anchors 32, which are preinstalled into the wall as is commonly known in the art.

The first step in installing the grab rail 10 of the present invention to a wall surface, is to install the wall anchors 32. This can be done by using the mounting holes 28 on each cylindrical flange 20 as a template to mark the proposed wall anchor positions on the wall surface. Appropriate holes are then drilled into the wall based on the marked-out positions and the wall anchors 32 are installed.

The grab rail 10, which is typically assembled when sold to the end user, is then placed over the wall anchors 32 such that each wall anchor is aligned with a corresponding mounting hole 28. The mounting screws can then be screwingly engaged with wall anchors to secure the grab rail to the wall surface. Advantageously, due to the grab rail 10 being preassembled, the end portions 14 will be correctly aligned. The covers 22, which are shown on FIG. 6 removed from the elbow formations 14 but are proposed to be floating over the end portions 14 at purchase, are then slid of the elbows and fixingly placed over cylindrical flanges 20 to conceal the mounting screws. The installation is now complete and the grab rail 10 is ready to use.

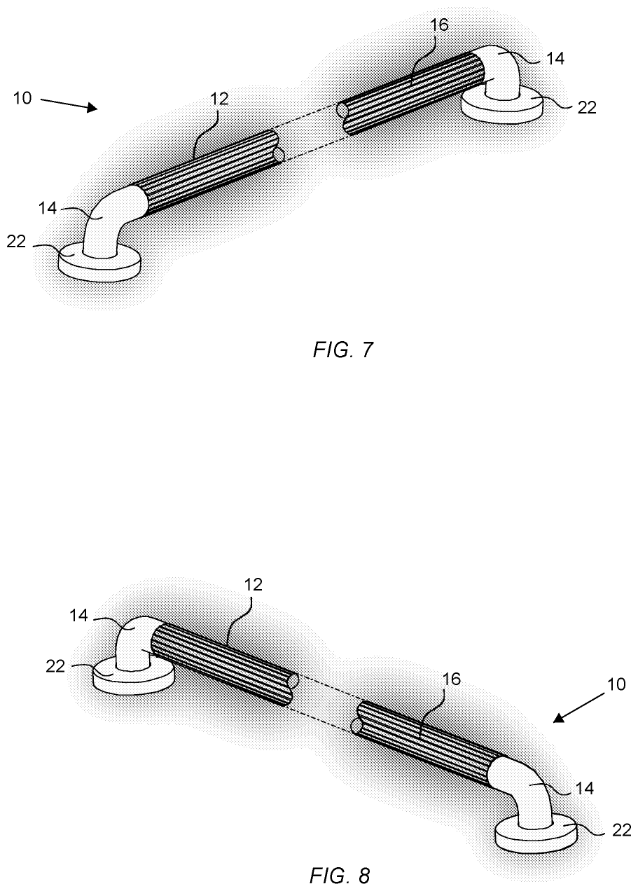

Referring now to FIGS. 7 and 8, the grab rail 10 is shown installed and illuminating under minimal light conditions. Once installed, the grab rail 10 of the present invention advantageously allows a user to safely find the grip region 12 even in low to no light conditions. Moreover, the contrasting glow colours between the end portions 14 and the central region grip 12, clearly indicate the grip region 10 and therefore the safe grip zones for a user. This is especially useful where the user has mobility issues such as arthritis because grip region 10 is a linearly extending elongate straight bar, making it easier to grab on to compared to the curved bars of the prior art. The grip formations 16 further provide assurance and provide additional grip as required.

It is proposed that the grab rail 10 of the present invention is to be installed primarily in bathrooms to provide a means of support for those that may be unsteady, infirm or other mobility issues. These areas typically have access to daylight or other light during the day and therefore the grab rail 10 is self-charged with energy during the day so that it emits light during low light conditions. Moreover, it is proposed that when not glowing, the grab rail 10 has a standard white or other coloured finish, not necessarily corresponding to the illuminated colours, so that appears like a normal hand rail.

Advantageously, the grab rail 10 of the present invention will available in a variety of lengths for the central grip region 10. Smaller versions are also available for space premium areas. It has a modular design making it inexpensive to manufacture.

It will be appreciated that the illustrated grab rail is able to provide improved safety and practical application due to its enhanced visual distinctiveness and easy to grab straight and elongate grab region 12.

Although the invention has been described with reference to a specific example, it will be appreciated by those skilled in the art that the invention may be embodied in many other forms.

1. A grab rail including:
an elongate central grip region extending in a linear direction; and
two end portions each including an elbow formation extending from and contiguous with elongate central grip region through to a direction generally transverse to elongate central grip region and terminating in a surface engaging formation,
wherein at least said central grip region includes a photo luminescent material such that the elongate central grip region accumulates energy under normal or day light conditions and automatically emits light under low light conditions to glow in dark.

2. A grab rail according to claim 1, including at least two photo luminescent materials that each generate a different colour light.

3. A grab rail according to claim 2, wherein one of said photo luminescent materials is for said elongate central grip region and the other of said photo luminescent materials is for said end portions.

4. A grab rail according to claim 1, wherein said central grip region and said end portions are moulded from a polymeric material.

5. A grab rail according to claim 4, wherein said photo luminescent material is incorporated into said polymeric material.

6. A grab rail according to claim 1, wherein said grab rail is reinforced with a metal material for high load applications.

7. A grab rail according to claim 1, wherein said grab rail is formed from a metal material for high load applications.

8. A grab rail according to claim 1, wherein said photo luminescent material is provided as a coating.

9. A grab rail according to claim 1, wherein said elongate central grip region includes a plurality of longitudinally disposed and outwardly extending grip formations.

10. A grab rail according to claim 9, wherein said outwardly extending grip formations are sized to enhance identification of the grip region both in normal light conditions and low light conditions.

11. A grab rail according to claim 1, wherein each surface engaging formation includes a mounting flange.

12. A grab rail according to claim 1, wherein each end portion includes an elbow formation.

13. A grab rail according to claim 12, wherein each elbow formation includes a conforming area of reduced diameter, said conforming area being adapted to co-axially and slidably engage with corresponding apertures at each end of said central grip region, during assembly of the of the grab rail.

14. A grab rail according to claim 1, wherein each end portion includes a cover.

15. A grab rail according to claim 1, wherein identification of said elongate central grip region is enhanced by using a brighter photo luminescent material or density of photo luminescent material, and/or by means of creating a greater surface area that results in increased light emission from that area.
